(19) United States
(12) Patent Application Publication
(10) Pub. No.: US 2017/0193179 A1
(43) Pub. Date: Jul. 6, 2017

(54) GRAPHICAL USER INTERFACE (GUI) FOR ACCESSING LINKED COMMUNICATION NETWORKS AND DEVICES

(71) Applicant: Clear Pharma, Inc., Westport, CT (US)

(72) Inventors: Dan Donovan, Westport, CT (US); T. Anthony Howell, Westport, CT (US)

(73) Assignee: Clear Pharma, Inc., Westport, CT (US)

(21) Appl. No.: 15/387,008

(22) Filed: Dec. 21, 2016

Related U.S. Application Data
(60) Provisional application No. 62/273,851, filed on Dec. 31, 2015.
(60) Provisional application No. 62/338,218, filed on May 18, 2016.

(51) Int. Cl. G06F 19/00; G06Q 50/00; G06F 3/0481

(52) U.S. Cl. CPC G06F 19/3418; G06F 3/04817; G06F 3/0481; G06Q 50/01; G06F 19/363

(57) ABSTRACT

A graphical user interface (GUI) including a computer-enabled social engagement section for enabling a user to post about a topic of interest, a computer-enabled rarerelated panel section for presenting information curated for the user based on the topic for which the user has posted in the social engagement section, to make learning about a disease accessible to the user, and a computer-enabled communication networks section for accessing linked communication networks in order to present curated information on a computer screen, wherein the curated information is generated by a compilation module including a scheduler module.

### CROSS REFERENCE TO RELATED APPLICATION

This application is a continuation-in-part of U.S. Provisional Patent Application No. 62/273,851 filed on Dec. 31, 2015 and U.S. Provisional Patent Application No. 62/338,218 filed on May 18, 2016, the complete disclosures of which, in their entireties, are herein incorporated by reference.

### BACKGROUND

Technical Field

The embodiments herein generally relate to a graphical user interface, and more particularly to a graphical user interface for accessing linked communication networks and devices.

Description of the Related Art

Medical research entities, hospitals, clinics, and medical schools generate and publish massive amount of information with respect to medical diagnostics and treatments. This information may be published in many different online sources and in many different formats. A patient looking for information about treatment of a particular medical condition may not be able to find or access the information he or she is looking for. There is a need to make medical information more accessible to the general public and to provide accurate information to patients about a particular condition based on the wealth of published medical data. In order to do so, various communication networks must be linked together and easily accessible for a user.

### SUMMARY

In view of the foregoing, an embodiment herein provides a graphical user interface (GUI), the GUI comprising a computer-enabled social engagement section configured to enable a user to post about a topic of interest to the user, a computer-enabled rarerelated panel section configured to present information curated for the user based on the topic for which the user has posted in the social engagement section, to make learning about a disease accessible to the user, and a computer-enabled communication networks section configured to access linked communication networks in order to present curated information on a computer screen, wherein the curated information is generated by a compilation module comprising a scheduler module configured to receive data from a database and determine a schedule for semantic analysis and curation of the retrieved data, a metadata information optimization module configured to curated the retrieved data by optimizing metadata of the retrieved data, based on the schedule determined by the scheduler module, and a semantical analysis module configured to provide semantical analysis on the retrieved data, based on the schedule determined by the scheduler module.

The GUI may further comprise a computer-enabled emotion web section configured to enable users to show graphically-represented empathy for others using graphical icons, wherein the emotion web section may comprise an emotion button section that is configured to, in response to a click by the user, to inquire how the user feels at a time of the inquiry, and accordingly present suggested graphical icons to the user. The GUI may further comprise a computer-enabled rarejourney web section configured to present a progression of the disease in a visual timeline comprising a detailed hover modal information and an emotional coloring, wherein the hover modal information may provide additional information in a modal popup window, and the emotional coloring may comprise a color-coded representation of an experience of the user during a plurality of events in the user's journey with the disease, wherein a specific color represents a specific experience of the user.

The GUI may further comprise a computer-enabled recruiting near me section configured to provide a location information of a plurality of trial research centers to the user by notifying the user when a center of the plurality of trial research centers is in a pre-specified radius of the user. The computer-enabled recruiting near me section may receive a location input from a global positioning system (GPS) module of a device configured to host the GUI, wherein the device may use the location input to determine the plurality of trial research centers.

The GUI may further comprise a computer-enabled curated for you section comprising a computer-enabled first rare disease web section configured to provide evidence and education about the disease to the user, and a computer-enabled second rare disease web section configured to provide social and media information to the user. The computer-enabled curated for you section may further comprise a computer-enabled third rare disease web section configured to provide news and meetings information to the user, a computer-enabled fourth rare disease web section configured to play a plurality of videos to the user, and a computer-enabled fifth rare disease web section configured to provide research grants information to the user.

Any of the computer-enabled first rare disease web section, the computer-enabled second rare disease web section, the computer-enabled third rare disease web section, the computer-enabled fourth rare disease web section, and the computer-enabled fifth rare disease web section of the computer-enabled curated for you section may be configured to be activated and deactivated by a computer device linked to an operator based on any of a level of education, a role in a community, and an experience of the user.

The GUI may further comprise a computer-enabled clinical trial participation section configured to increase a participation of the user in a clinical trial research by providing a list of clinical trials sorted by increasing to decreasing probability of enrollment of the user.

An embodiment herein provides a computer display screen presenting a graphical user interface (GUI), the GUI comprising a computer-enabled social engagement section configured to enable a user to post about a topic of interest to the user, a computer-enabled rarerelated panel section configured to present information curated for the user based on the topic for which the user has posted in the computer-enabled social engagement section, to make learning about a disease more convenient to the user, and a computer-enabled communication networks section configured to access linked communication networks in order to present curated information on a computer screen, wherein the curated information is generated by a compilation module comprising a scheduler module configured to receive data from a database and determine a schedule for semantic analysis and curation of the retrieved data, a metadata information optimization module configured to curated the retrieved data by optimizing metadata of the retrieved data, based on the schedule determined by the scheduler module, and a semantical analysis module configured to provide semantical analysis on the retrieved data, based on the schedule determined by the scheduler module, wherein the compilation module receives scraped information generated by a scraper module configured to scrape the Internet for information related to the disease.

The compilation module may receive automatically collected information from application program interfaces (APIs) of a third party website over the Internet.

An embodiment herein provides a method for curating medical data about a plurality of diseases for displaying on a computer display screen via a graphical user interface (GUI), the method comprising determining whether a data source containing information about the plurality of diseases has an application program interface (API), receiving first data about the diseases from the data source when the data source has the API, gathering second data about the diseases using a scraping module to scrape the Internet, and transforming a format of any of the first data or the second data for storing in a database, wherein the database is communicatively accessible to the GUI and the transformed format of the first and second data is configured to be compatible to be presented on the GUI, and wherein the GUI is hosted on a screen, and the GUI is configured to interact with the API in response to a physical input on the screen when the data source has an API.

The method may further comprise utilizing artificial intelligence to mine the database for relevant information to the diseases, utilizing a big data analytics tools to find trends and connections in the relevant information to the diseases, and scoring the relevant information to the diseases based on any of relevancy, quality, and appropriateness for a community audience.

The method may further comprise adding meta-data to the relevant information to the diseases for a categorization purpose, wherein the categorization comprising a rare disease category, displaying the rare disease category of the relevant information to the diseases on the GUI, and regularly updating the rare disease category of the relevant information.

The GUI may further comprise a computer-enabled social engagement section configured to enable a user to post about a topic of interest to the user, a computer-enabled rarerelated panel section configured to present information curated for the user based on the topic for which the user has posted in the computer-enabled social engagement section, to make learning about the rare disease more convenient to the user, and a computer-enabled communication networks section configured to access linked communication networks in order to present curated information on a computer screen, wherein the curated information is generated by a compilation module comprising a scheduler module configured to receive data from a database and determine a schedule for semantic analysis and curation of the retrieved data, a metadata information optimization module configured to curated the retrieved data by optimizing metadata of the retrieved data, based on the schedule determined by the scheduler module, and a semantical analysis module configured to provide semantical analysis on the retrieved data, based on the schedule determined by the scheduler module.

The GUI may further comprise a computer-enabled emotion web section configured to enable users to show graphically-represented empathy for others using graphical icons, wherein the computer-enabled emotion web section may comprise an emotion button section that is configured to, in response to a click by the user, to inquire how the user feels at a time of the inquiry, and accordingly present suggested graphical icons to the user.

The GUI may further comprise a computer-enabled rarejourney web section configured to present a progression of the disease in a visual timeline comprising a detailed hover modal information and an emotional coloring, wherein the hover modal information provides additional information in a modal popup window, and the emotional coloring comprises a color-coded representation of an experience of the user during a plurality of events in the user's journey with the disease, wherein a specific color represents a specific experience of the user.

The GUI may further comprise a computer-enabled recruiting near me section configured to provide a location information of a plurality of trial research centers to the user by notifying the user when a center of the plurality of trial research centers is in a pre-specified radius of the user. The computer-enabled recruiting near me section may receive a location input from a global positioning system (GPS) module of a device configured to host the GUI, wherein the device may use the location input to determine the plurality of trial research centers.

The GUI may further comprise a computer-enabled curated for you section comprising a computer-enabled first rare disease web section configured to provide evidence and education about the disease to the user, a computer-enabled second rare disease web section configured to provide social and media information to the user, a computer-enabled third rare disease web section configured to provide news and meetings information to the user, a computer-enabled fourth rare disease web section configured to play a plurality of videos to the user, and a computer-enabled fifth rare disease web section configured to provide research grants information to the user, wherein any of the first rare disease web section, the second rare disease web section, the third rare disease web section, the fourth rare disease web section, and the fifth rare disease web section of the curated for you section is configured to be activated and deactivated by an operator based on any of a level of education, a role in a community, and an experience of the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating a system architecture according to an embodiment herein;

FIG. 2 is a block diagram illustrating a system architecture according to an embodiment herein;

FIG. 3 is a block diagram illustrating a high level system architecture according to an embodiment herein;

FIG. 4 is a flowchart illustrating a method according to an embodiment herein;

FIG. 5 is a flowchart illustrating a method according to an embodiment herein;

FIG. 6 is a diagram illustrating a graphical user interface (GUI) according to an embodiment herein;

FIG. 7 is a schematic diagram illustrating a method according to an embodiment herein; and

FIG. 8 is a block diagram illustrating a computer system according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In an exemplary embodiment, the various modules described herein and illustrated in the figures are embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic; operations (e.g., Add, Subtract, etc.), bitwise logical operations (AND, OR, XOR, etc.), bit shift operations arithmetic, logical, rotate, etc.), complex operations (e.g., using single clock calculations, sequential calculations, iterative calculations, etc.). The data objects may be configured as physical locations in computer memory and can be a variable, a data structure, or a function. In the embodiments configured as relational databases (e.g., such Oracle® relational databases), the data objects can be configured as a table or column. Other configurations include specialized objects, distributed objects, object oriented programming objects, and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

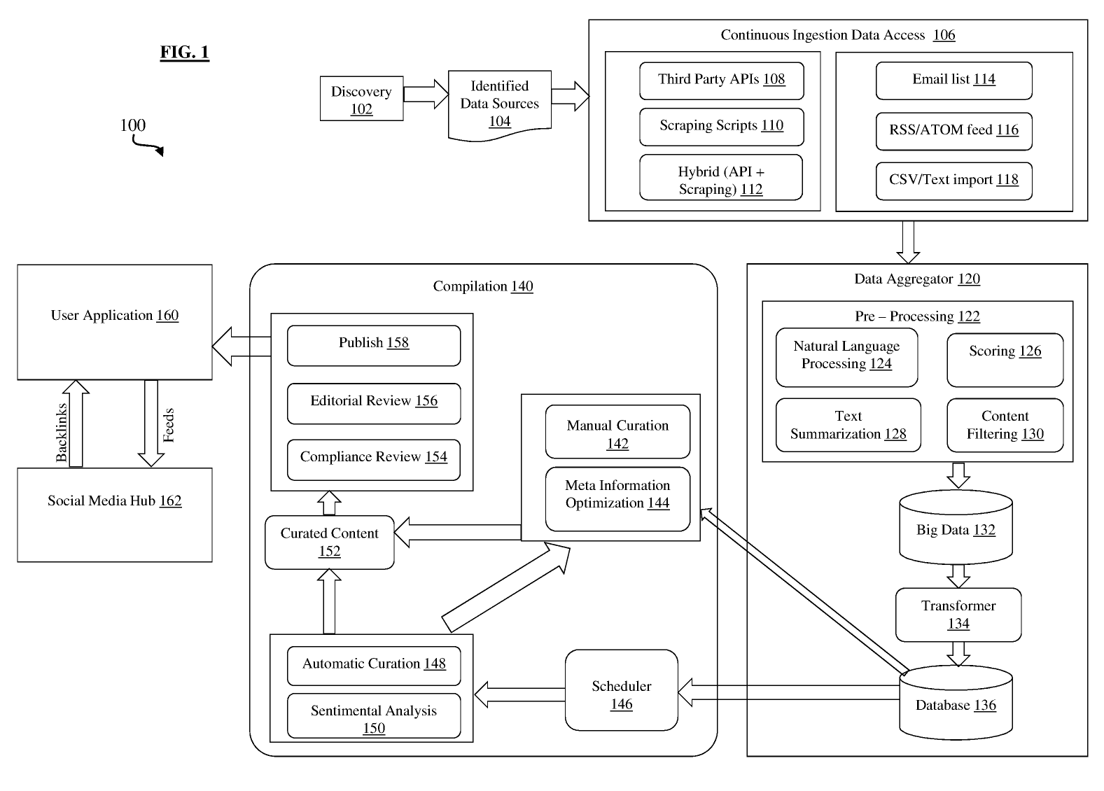

The embodiments herein provide a graphical user interface to allow a user to easily access linked communication networks and devices, and could be used by a patient to receive medical information about a condition and interact with other patients and healthcare professionals. In the embodiments herein, compilers and assemblers may use data stored in databases and transform data format to be representable in the graphical user interface. Referring now to the drawings, and more particularly to FIGS. 1 through 8, where similar reference characters denote corresponding features consistently throughout the figures, there are shown preferred embodiments.

FIG. 1 illustrates a system architecture 100 for curating medical data according to an embodiment herein. The system 100 may include a discovery module 102. In an embodiment, the discovery module 102 may be configured to research, plan, or discover medical data. Data discovery may be achieved for example by exploration of publicly available data sources, by online feed gathering, or by email list signups. In an embodiment, the discovery of data may additionally be performed by a researcher. In an embodiment, an editor may review the data.

The discovery module 102 may be communicatively coupled to identified data sources 104. In an embodiment, the identified data sources 106 may include, for example, PubMed®, Orphanet®, Online Mendelian Inheritance in Man® (OMIM®), resources published by the National Institute of Health (NIH), or any other database that include clinical trials such as ClinicalTrials.gov.

In an embodiment, system 100 includes several data sources in relation to rare diseases posts, blogs, articles, videos and visuals etc. Such data may be collected from several identified data sources 104. In embodiments, data sources 104 are publically hosted websites from where the data can be ingested through Application Program Interfaces (APIs) or scraping.

In an embodiment, the system 100 includes a continuous ingestion data access module 106. Continuous ingestion data access module 106 may be configured to continuously monitor identified data sources 104 of medical information for receiving or gathering new data. In an embodiment, continuous ingestion data access module 106 includes third party APIs 108. Some of the identified data sources 104 may provide APIs through which the medical data can be accessed by continuous ingestion data access module 106, using third party APIs 108.

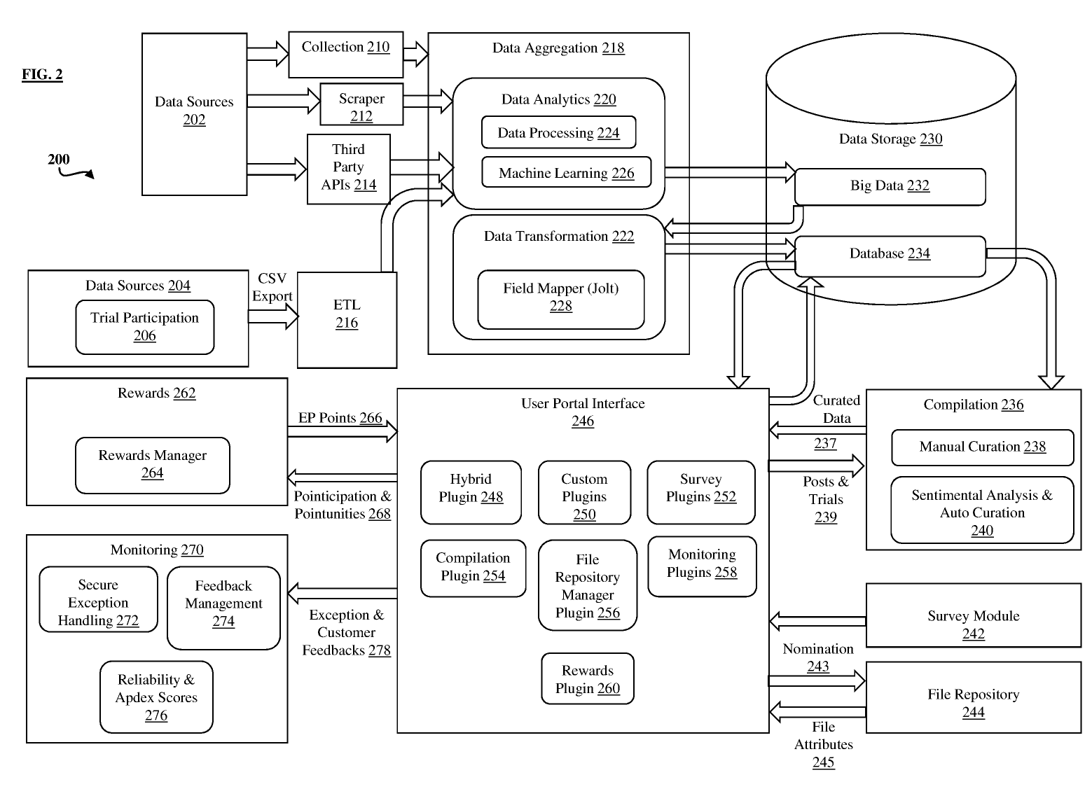

In an embodiment, continuous ingestion data access module 106 includes scraping scripts 110 configured to directly scrape relevant medical data from the identified data source 104. The scraping scripts 110 may be developed using Javascripts which can be executed by a web scraper hosted as a service on the trigger of a Representational State Transfer (ReST) API call. ReST may rely on a stateless, client-server, cacheable communications protocol—and in some embodiments, the HTTP protocol is used. ReST may be an architecture style for designing networked applications. Data may be scraped from identified data sources 104 using a Scraper Engine or a Web Scraper of the Scraper module 212 (of FIG. 2). The Web Scraper may run the scraping scripts, which will in turn call the ReST APIs provided by the different data sources and aggregate the data into the database.

In an embodiment, continuous ingestion data access module 106 includes a hybrid API scraping module 112. The hybrid API scraping module 112 may be configured to combine the capabilities of a third party API module to automatically receive updates from the identified data source 104, with capabilities of a scraper that proactively looks for and scrapes relevant medical data from the identified data sources 104. In an embodiment, the web scraper is hosted as a service which executes scraping scripts 110 on the trigger of a ReST API call. Cron jobs are set to call scraper APIs at a preset interval which executes the script and fetch data. “Cron” may be a time-based job scheduler, for example in Unix-like operating systems (such as Linux, FreeBSD, Mac OS etc. . . . ). Such time-based jobs or tasks may be referred to as “cron jobs”. A cron “daemon” may run on such operating systems. A daemon may refer to a program that runs in the background all the time, usually initiated by the operating system. In an embodiment herein, a cron daemon is responsible for launching cron jobs on schedule.

In an embodiment herein, the newly fetched data is compared with an existing copy stored in the big data storage 132 to determine if there are any changes. In another embodiment herein, the newly fetched data is compared with an existing copy stored in the relational database management system (database) 136 to determine if there are any changes. If any change exists, it is provided for curation. However, fetching enormous amount of data through sequential requests is a challenging task. The embodiments herein overcome this challenge by dividing the job into small units of fetching data based on the load and execute each unit in separate threads on the web scraper.

In an embodiment, continuous ingestion data access module 106 includes an email list module 114. Email list module 114 may be configured to receive data updates by subscribing to an email list of the identified data source 104. In an embodiment, continuous ingestion data access module 106 may include a Rich Site Summary (RSS) feed or an ATOM feed module 116 to receive updates from the identified data source 104. Continuous ingestion data access module 106 may include a Comma Separated Values (CSV) text import module 118 to receive updated medical data from the identified data source 104.

In an embodiment, system 100 includes a data aggregator 120. In an embodiment, data aggregator 120 is configured to receive data from the continuous ingestion data access module 106. Data aggregator 120 pre-processes the data after collection from the data source 104. In an embodiment, data aggregator 120 may include a pre-processing module 122. Preprocessing module 122 may include a natural language processing (NLP) module 124. The NLP module 124 uses natural language processing to improve the accuracy of the collected data from the data source 104. An embodiment herein uses machine learning to improve the accuracy based on the probability of the data being published with respect to the data aggregated or collected from each of the data sources 104. Pre-processing module 122 may further include a scoring module 126. In an embodiment, the scoring module 126 is configured to assign a score to portions of the data received from the data source 104, for example based on relevance or usefulness. In an embodiment herein, the scoring module 126 scores data based on hierarchical and relevancy based taxonomy matching.

Pre-processing module 122 may include a text summarization module 128. In an embodiment, text summarization module 128 may be configured to compress text data received from data source 104. Pre-processing module 122 may further include a content filtering module 130. In an embodiment, content filtering module 130 may be configured to filter out irrelevant portions of data received from identified data sources 104.

Data aggregator module 120 may include a big data database 132. big data database 132 receives data from pre-processing module 122. In an embodiment, big data database 132 is configured to store a large quantity of historic data received. Data aggregator module 120 may include a transformer module 134. Transformer module 134 receives input data from big data database 132. In an embodiment, transformer module 134 includes a field mapper configured to map fields of data for transforming the data format to be suitable for storage. In some embodiments herein, field names/labels may be different in different data sources. In an embodiment herein, the scraped data is run through a transformer module of the field mapper 228 to map field name to application specific predefined data structure. Data aggregator 120 includes a relational database management system 136. Relational database management system 136 stores transformed data by transformer module 134.

System 100 includes a compilation module 140. In an embodiment, compilation module 140 is configured to provide both manual and automatic curation to make the content more useful to be used or displayed to a user.

Compilation module 140 may be configured to use algorithms for sentimental analysis and automatically adding proper key words to the data. The data used by compilation module 140 may be collected directly from relational database management system 136. Compilation module 140 may be configured to provide the interface to manually curate the content as a multistep process like edit, curate, review, publish etc. Each of these steps may be carried out by a computer linked to an operator having different roles such as editor, curator, reviewer, etc. Compilation module 140 may be a module hosted in a server.

Compilation module 140 may include a scheduler module 146. Scheduler module 146 receives data from relational database management system 136 and schedules semantic analysis and curation of the data. In an embodiment, scheduler module 146 transmits data received from relational database management system 136 to sentimental analysis module 150 and automatic curation module 148.

In an embodiment, manual curation module 142 and meta information optimization module 144 receive data directly from relational database management system 136 and curates the retrieved data by optimizing its metadata. Curated data generated by manual curation module 142, or by curated content 152 are stored in a curated content storage device 152. Compilation module 140 may further include a compliance review module 154, an editorial review module 156, and a publish module 158. Compilation module 140 publishes the curated data to user application 160. User application 160 may be accessed by social media hubs 162 through feeds and backlinks. In an embodiment herein, posts may be shared to social media thereby creating backlinks to bring users who are interested to the platform.

FIG. 2, with reference to FIG. 1, is a schematic diagram illustrating a system 200 for curating medical data according to an embodiment herein. In an embodiment, system 200 includes data sources 202. In an embodiment, system 200 uses several data sources 202 to obtain information about rare diseases. Data sources 202 may include electronic documents in the form of Internet posts, blogs, online articles, videos, and visuals etc. These data can be collected from several databases, for example, PubMed®, Orphanet®, Online Mendelian Inheritance in Man® (OMIM®), MedLinePlus®, resources published by the National Institute of Health (NIH), or any other database that include clinical trials, including ClinicalTrials.gov. Data sources 202 may be publically hosted websites from which the data can be ingested through APIs or scraping.

In an embodiment herein, system 200 includes data sources 204. Data sources 204 may include trail participation 206 source. Data sources 204 may be configured to export data to Extract, Transform and Load (ETL) module 216 using comma separated values (CSV). ETL module 216 may extract and transform the data for proper storage format adapted for querying and analysis.

In an embodiment herein, system 200 includes collection module 210. Collection module 210 may be a software component. Collection module 210 is configured to collect information about physicians or caregivers from different data sources. In an embodiment, collection module 210 is configured to store details of physicians or caregivers in a memory device.

In an embodiment herein, system 200 includes a scraper module 212. Scraper module 212 is configured to scrape data from publically available sources on the Internet. In an embodiment, the data scraped by the scraper module 212 may not be available through the collection module 210.

In an embodiment, system 200 includes a third party APIs module 214. Some data sources 202, for example PubMed®, may provide APIs through which the data can be accessed. Third party APIs module 214 uses the APIs provided by the third parties to access the data. Scraper module 212 or third party APIs module 214 may be configured to have a one-time batch data collection from data sources 202 or continuously collect data from data sources 202.

System 200 may include a data aggregation module 218 configured to pre-process the data collected by collection module 210, scraper module 212, third party APIs 214, or ETL module 216, before the data is saved into a database.

In an embodiment, data aggregation module 218 includes data analytics module 220 and data transformation module 222. Data analytics module 220 may be configured to analyze incoming data from data sources 202, through some automated algorithms like machine learning, and natural language processing (NLP) to improve the accuracy of the data. Data analytics module 220 may include data processing 224 module and machine learning 226 module. Data transformation module 222 may be configured to transform the data to a format required by other modules of system 200. Data transformation module 222 may include a field mapper module 228 to perform the format transformation.

System 200 may include data storage 230. Data storage 230 may be configured to store the data used by system 200. After pre-processing by data analytics 220, data will be stored directly into the big data storage 232 which may also include all the historical data. Data transformation module 222 receives input data for format transformation from big data storage 232. The transformed data is then stored in the relational database management system (database) 234.

System 200 may further include a compilation module 236. Compilation module 236 may be a Word Press plugin configured to perform both manual and automatic curation to make the content more realistic to be used or displayed on a computer screen and accessible through a GUI.

In an embodiment, compilation module 236 may include a sentimental analysis and automatic curation module 240. Sentimental analysis and automatic curation module 240 may be configured to provide sentimental analysis and adding proper key words automatically. The data for this process will be collected directly from the relational database management system 234.

In an embodiment, compilation module 236 may also include a manual curation module 238. Manual curation module 238 may be configured to provide an interface to manually curate the content as a multistep process, such as, edit, curate, review, publish, etc. Each of these steps may be carried out by a computer linked to a user having different roles such as editor, curator, reviewer, etc. In an embodiment, compilation module 236 may be a software component/content management (e.g., WordPress, etc.) plugin hosted in a server.

System 200 may include a survey module 242. Survey module 242 may be configured to implement different surveys which is needed for user portal GUI users to answer their profile/user data expansion.

In an embodiment, system 200 includes a file repository module 244. In an embodiment, file repository module 244 is a file repository in which the user can store different file type formats such as txt, pdf, tiff etc. In an embodiment, file repository 244 may be an open source third party software hosted on a server.

System 200 may include a GUI-accessible user portal interface module 246. In an embodiment, user portal interface module 246 is the user interface portal accessible through a GUI where a user can join the user portal interface program and participate in different engagements which the portal is offering, for example, access to the curated medical data, or share information with other users. In an embodiment, user portal interface module 246 may be developed on top of a content management system (e.g., WordPress, etc.) and by using PHP Hypertext Preprocessor (PHP) as the core technology. In an embodiment, user portal interface module 246 accesses the data from relational database management system 234. User portal interface module 246 may offer a functionality to its users to collect different articles or posts and save it into file repository 244.

In an embodiment, compilation module 236 provides curated data 237 to user portal interface module 246 and receives posts and trials 239 from user portal interface module 246 for curation. User portal interface module 246 may receive file attributes 245 from the file repository 244 and provides nomination 243 of content by users to the content curators for manual evaluation and potential inclusion in the database to the file repository 244.

In an embodiment, user portal interface module 246 includes plugins configured to interface with other modules in system 200. User portal interface module 246 may include any of hybrid plugin 248, custom plugins 250, survey plugins 252, compilation plugin 254, file repository manager plugin 256, monitoring plugins 258, and rewards plugins 260.

In an embodiment herein, the hybrid plugin 248 is used to scrape data from the identified data sources 202 and get notified when data is updated in a given data source of the data sources 202. The custom plugins module 250 may include sub-modules to achieve different custom functionalities. The custom plugins 250 may include a bookmark module, configured to be used as a bookmark-like feature, a user portal interface care module configured to be used for like/unlike functionality, a user settings module configured to adjust user settings, a user portal interface newest members module configured to retrieve a list of users who have recently joined the platform, and a user portal interface wheel module configured to display social and media interests sections.

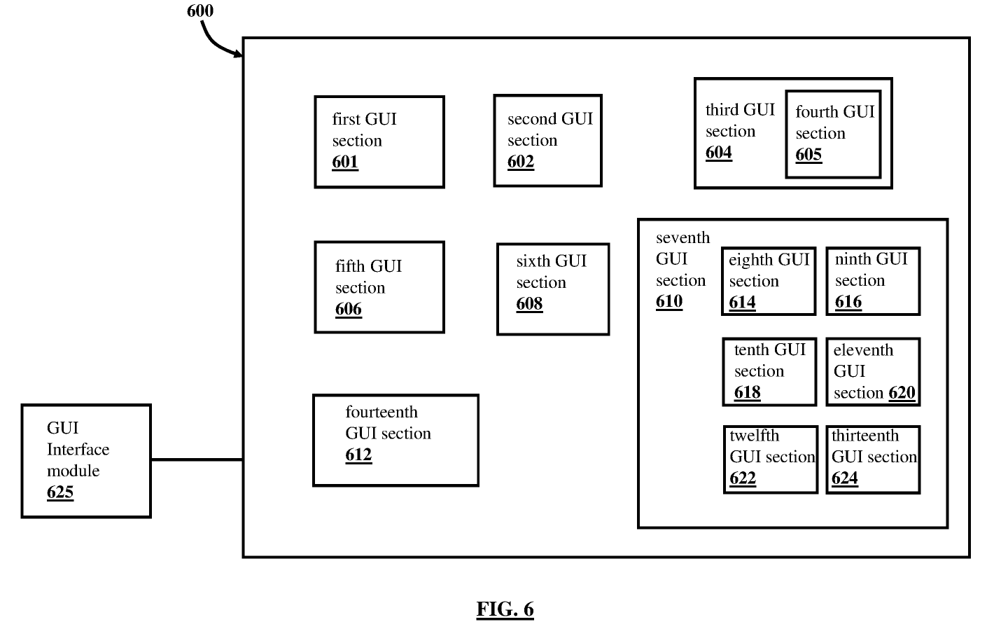

The survey plugins 252 is configured to manage online surveys such as in a rarejourney web section 606 (of FIG. 6). The compilation plugin 254 is used for any of data curation and review, edit, and update of data. In an embodiment herein, the file repository manager plugin 256 is used for managing a file repository in which the user can upload and store different types of files such as any of txt, pdf, images, etc.

The monitoring plugin 258 is an application monitoring plugin configured to monitor performance of an application, for example to capture errors or exceptions. The rewards plugin 260 is a reward calculation engine for encouragement power (EP) functionality. Rules for an EP may be set in the rewards plugin 260 and user activities may be sent dynamically to the rewards plugin 260 configured to return user's total EP points 266 based on the rules set.

In an embodiment, system 200 includes a rewards module 262. In an embodiment, rewards module 262 is a platform configured to calculate the rewards for a user based on his activity, engagement, or participation in a third party application. Rewards module 262 may include a rewards manager module 264. User portal interface module 246 may also be configured to offer some points called engagement power for its users based on the activities, engagement, or participation they are doing in the user portal interface platform. In an embodiment, rewards module 262 is configured to provide EP points 266 to user portal interface module 246. In an embodiment herein, the EP points 266 are any of points, rewards, and recognition effort by a user. By simply participating in the platform (for example by any of logging in, sharing, posting, nominating, saving to a bookmark module, etc.), the user may receive rewards in the form of small amounts of “encouragement points” (EP), which can accumulate as the user continues to be active. There are opportunities for larger amounts of EP points 266 for “extra participation” in the platform, for example by activities filling a questionnaire, becoming a mentor, filling out the rarejourney web section 606 (of FIG. 6), etc. In an embodiment herein, the questionnaire is provided to the user by the survey plugins 252. In an embodiment, rewards module 262 is hosted on a server.

User portal interface module 246 may be configured to provide pointicipation and pointunities 268 to user portal interface module 246. In an embodiment herein, encouragement to a user may be broken down into two primary categories: pointicipation and pointunities. In an embodiment herein, pointuinities are nonspecific user engagement activities of the platform for which EP point 266 allocations would not be made known to the user, for example by interactions such as posting, sharing, talking, clicking on content links, time on site, etc. These may referred to as “fundamental user interactions” for which no or a low amount of EP points 266 are available for each click. In an embodiment herein, pointicipation is specific user engagement, for which actual EP points 266 amounts will be offered for successful completion of an activity. For example, the user may be offered 250 EP points for the successful completion of a questionnaire or 150 points for entering user's rarejourney web section 606 (of FIG. 6).

In an embodiment, system 200 includes a monitoring module 270. In an embodiment, monitoring module 270 is a monitoring system configured to capture a third party application's performance telemetry data used to determine the performance of the application. User portal interface module 246 may be configured to leverage monitoring application's capabilities to monitor the application performance, capture the errors and exceptions that are being occurred within the application.

In an embodiment, monitoring module 270 is configured to provide a customer feedback functionality to capture the feedbacks from the end user like complaints, comments, suggestions etc. Monitoring module 270 may be configured to input exception and customer feedbacks 278 from user portal interface module 246. Monitoring module 270 may include feedback management 274 configured to receive the inputted exception and customer feedbacks 278. Monitoring module 270 may also include secure exception handling module 272 configured to provide security and encryption/decryption to the received exception and customer feedbacks data 278. Monitoring module 270 may further include reliability and apdex scores module 276 configured to provide reliability analysis and scoring of the received exception and customer feedbacks 278. In an embodiment, monitoring module 270 is hosted on a server.

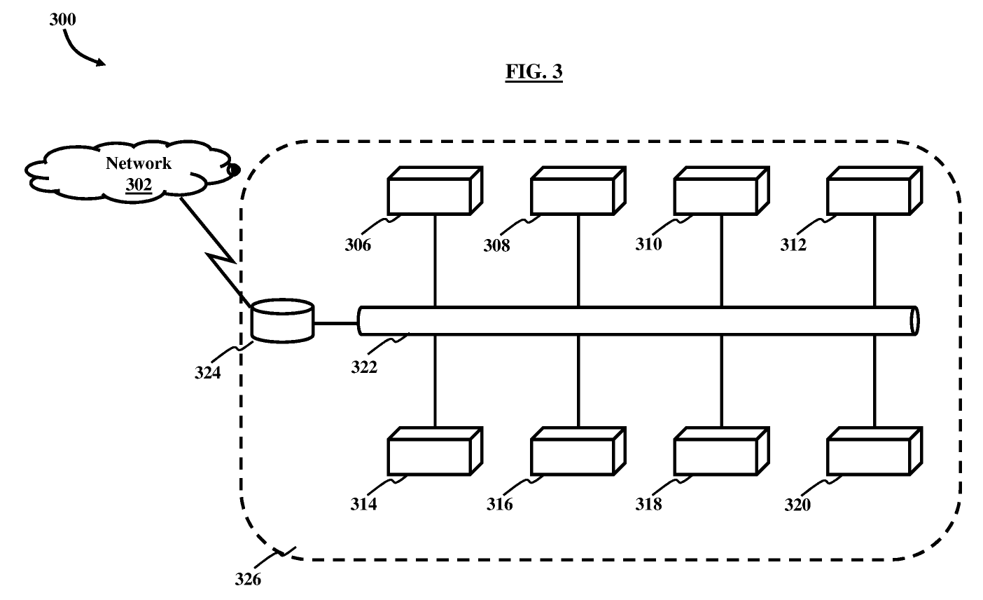

FIG. 3, with reference to FIGS. 1 and 2, is a schematic diagram illustrating a system 300 according to an embodiment herein. System 300 includes a trusted LAN 326. In an embodiment, trusted LAN 326 is a secure LAN configured to use a authentication method to authorize its users to access resources on the LAN 326. Trusted LAN 326 may include router 324 connecting a network switch 322 to network 302.

In an embodiment, network 302 may be a wireless communications network or a wire line communications network. The wireless communications network may be for example, but not limited to, a digital cellular network, such as Global System for Mobile Telecommunications (GSM) network, Personal Communication System (PCS) network, or any other wireless communications network. The wire line communications network may be for example, but not limited to, a Public Switched Telephone Network (PSTN), proprietary local and long distance communications network, or any other wire line communications network. One or more networks may be included in the communication network 302 and may include both public networks such as the Internet, and private networks and may utilize any networking technology and protocol, such as Ethernet, Token Ring, Transmission Control Protocol/Internet Protocol (TCP/IP), or the like to allow interaction among various nodes such as router 324 with any other node in the network.

In an embodiment, network switch 322 connects any of servers 306, 308, 310, 312, 314, 316, 318, and 320 to the trusted network 326. In an embodiment, server 306 is a scraper service server hosting the scraper module 212. Server 308 may be a data aggregation service hosting the data aggregation module 218. Server 310 may be a server such as an Apache Cassandra server hosting big data module 232. Server 312 may be a relational database management system server hosting the relational database management system 234. Server 314 may be a server hosting the rewards module 262. Server 316 maybe a monitoring server hosting monitoring module 270. Server 318 may be a user portal interface platform server hosting user portal interface module 246. Server 320 maybe a server hosting the file repository 244.

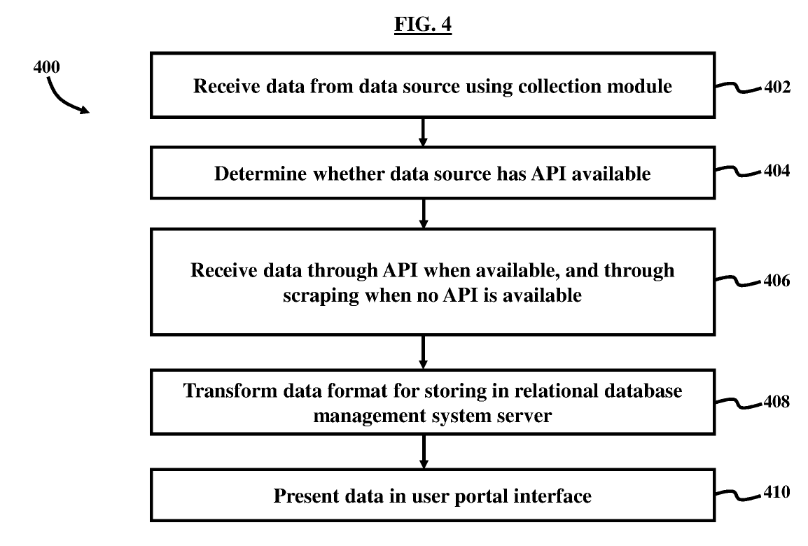

FIG. 4, with reference to FIGS. 1 through 3, is a flowchart illustrating a method 400 according to an embodiment herein. At step 402, method 400 receives data from data sources 202 using collection module 210. At step 404, method 400 determines whether data source 202 has an API. At step 406, if data source 202 has an API, method 400 receives data from the data source 202 through the API, and if no API is available for the data source 202, method 400 gathers data from the data sources 202 through scraping, using scraper module 212. At step 408, method 400 transforms the format of the gathered data for storing in relational database management system server 312. At step 410, method 400 presents data using user portal interface module 246.

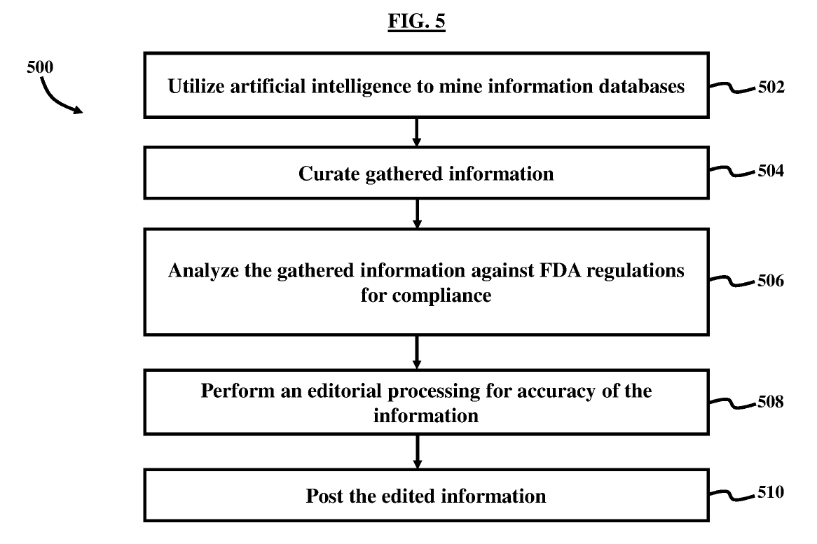

FIG. 5, with reference to FIGS. 1 through 4, is a flowchart illustrating a method 500 according to an embodiment herein. At step 502, method 500 may utilize artificial intelligence to mine information databases for information about one or more diseases. An embodiment utilizes visual technologies attached to one or more mega-databases, for example big data storage 132, relational database management system 136, or data storage 230. Immense amount of information may be gathered in the mega-databases. An embodiment utilizes big data analysis tools to find trends and connections in the gathered information.

At step 504, method 500 may selectively curate the gathered information. In an embodiment, an expert data analytics tool may sift through and score the gathered information. In an embodiment, the information is scored based on relevancy, quality, and appropriateness for a community audience. In an embodiment, a user portal interface 246 may only accept highest scoring information. At step 506, method 500 may analyze the gathered information against FDA regulations for compliance. In an embodiment, an expert data analytics tool analyzes the information for compliance with FDA regulations. Method 500 may review the information against any of FDA “off-label” promotion regulations, social media guidance, and a sponsor's particular compliance concerns.

At step 508, method 500 may perform an editorial processing for the accuracy of the information. Method 500 may add meta-data to the information for categorization purposes. For example, method 500 may add a specific tag to the information to indicate that the information is related to a rare disease. At step 510, method 500 may post the edited information. Method 500 may regularly update the posted information repeating any of steps 502 to 508, or by receiving updates and new information from the user community.

FIG. 6, with reference to FIGS. 1 through 5, is a diagram illustrating a GUI 600, according to an embodiment herein. In an embodiment herein, the GUI 600 may be included in any of the user application 160, the social media hub 162, and the user portal interface module 246. In an embodiment herein, sections of the GUI 600 may be self-contained units or items which can be enabled or disabled from a backend configuration or system wide settings interface. In an embodiment herein, a platform administrator can decide whether to make some of the GUI 600 sections available or not to the users.

In an embodiment herein, the GUI 600 may include a social engagement section (first GUI section) 601. In an embodiment herein, the social engagement section 601 may be used by a user to post about a topic of interest to the user. In an embodiment herein, the GUI 600 may include a combined rareRelated panel/knowledge serving section (second GUI section) 602. The rareRelated panel/knowledge serving section 602 may be configured to present information to a user that make learning about a disease more convenient. In an exemplary embodiment, the rareRelated panel/knowledge serving section 602 invites the user to go deeper into knowledge that has been curated for them on the topic for which they have posted in the social engagement section 601.

In an embodiment herein, the GUI 600 may include a Sentiment Palette® section & emotional palette section (ClickEmote® section, emotion web section, or third GUI section) section 604. The ClickEmote® section 604 may be configured to make emotion communication more convenient, using graphical icons. The ClickEmote® section 604 may invite users to quickly and easily show empathy for others (who are also having their behaviors changed and reinforced as they experience the receipt of empathy) and express their own feelings during their own patient journey. In an embodiment herein, the ClickEmote® section 604 may be a connection to a “device” world (aka a “digital world”, which the user will be already familiar with and can be connected to) through an application that provides the opportunity for users to click on emotion buttons (fourth GUI section) 605 that inquire how they are feeling at that moment, and based on the inquiry suggest graphical icons to the user. In an embodiment herein, the ClickEmote® section 604 may be a selection mechanism for choosing among various emotional states as indicated by icons to provide supportive feedback in a community and curated conversation context.

In an embodiment herein, the GUI 600 may include a rarejourney web section 606. The rarejourney web section (fifth GUI section) 606 may be configured to make sharing and learning about the natural history progression of disease more convenient by translating events in to a visual timeline with detailed hover modal information and emotional coloring. The modal information may refer to the additional information that shows up in a modal popup window. And emotional coloring may be the representation of what the user has felt during each of the events in their journey with a disease, like ‘what they went through when they were first diagnosed’, ‘what went through when their diagnose report came in’, ‘what they felt when the disease got cured’, etc. These may be captured using a ‘text and color’ palette, when they fill in a rare journey web section questionnaire. In addition, the rarejourney web section 606 may be transformed into a “4square” type of device function when people are visiting any of their doctors, medical centers, clinical trial centers, phlebotomists, hospitals etc. The user may “check in” which will end up on their rarejourney web section timeline. In an embodiment herein, the user may enter the diagnose details to rarejourney web section forms. The user may choose to either keep the details personal, or share with team or make public to the entire platform users. The data may show up in the Rarejourney web section timeline based on the user's privacy settings.

In an embodiment herein, the GUI 600 may include a recruiting near me section 608. The recruiting near me section (sixth GUI section) 608 may be configured to increase participation in clinical trial research by providing information about geographic locations of centers. In addition, this could be translated into a user device by an app with a setting to ‘notify’ when a center is within a pre-specified radius of the carrier/wearer of the device. The recruiting near me section 608 may list the clinical trials near to the specified location. In an embodiment, the user device may be any of a smart phone, a smart watch, and an electronic device. The recruiting near me section 608 section may use a GPS module of the user device to determine any of the location of the user and the location of the centers.

In an embodiment herein, the GUI 600 may include a curated for you section (seventh GUI section) 610 that may include any of a first rare disease web section (eighth GUI section) 614 configured to provide evidence and education, a second rare disease web section (tenth GUI section) 616 configured to provide social and media information, a third rare disease web section (eleventh GUI section) 618 configured to provide news and meetings information, a fourth rare disease web section (twelfth GUI section) 620 configured to provide videos and visuals, a fifth rare disease web section (thirteenth GUI section) 622 configured to provide research grants information, and a sixth rare disease web section (ninth GUI section) 624 configured to provide information about people and places. The curated for you section 610 may be configured to customize knowledge based upon the user's level of education, role in the community, and experience (whether the user is any of a veteran, newbie, physician, caregiver, patient, and advocate). In an embodiment, any of the first rare disease web section 614, second rare disease web section 616, third rare disease web section 618, fourth rare disease web section 620, fifth rare disease web section 622, and sixth rare disease web section 624, of the curated for you section is configured to be activated deactivated, or customized by an operator based on any of the user's level of education, role in the community, and experience.

In an embodiment herein, the GUI 600 may include a trial participation section (fourteenth GUI section) 612. The trial participation section 612 may be configured to increase the participation in clinical trial research by providing a list of clinical trials organized by increasing to decreasing probability of enrollment. In an exemplary embodiment herein, the trial participation section 612 retrieves the clinical trials data from the ClinicalTrials.gov webpage and after determining which trials match certain user preferences and data, displays the retrieved information and a mapped course to the user and presents contact tools using email and internet callback requests.

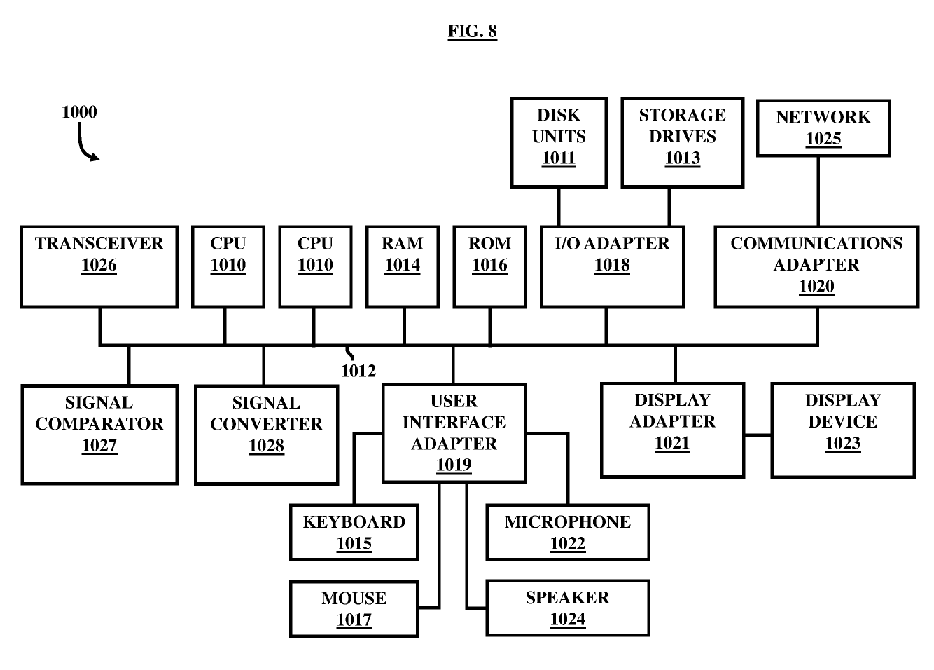

In an embodiment herein the GUI 600 is communicatively coupled to a GUI interface module 625 configured to provide curated data from any of the system architecture 100 and system 200 for displaying the curated medical data in the GUI 600. In an embodiment herein, the GUI interface module 625 is communicatively coupled to the system 100 or the system 200 using any of the communication network technologies provided by system 300 in FIG. 3. In an embodiment herein, any of the big data 132 of the system 100 and the data storage 230 of the system 200 is communicatively accessible to the GUI 600 and the transformed data format in any of the big data 132 and the data storage 230 is compatible to be presented on the GUI 600. The GUI 600 may be configured to be displayed in a screen, for example the display device 1023 (FIG. 8). In an embodiment herein, and the GUI 600 is configured to interact with the third party APIs 108 in response to a physical input on the screen 1023. In an embodiment herein, the physical input on the screen 1023 may be a click by a user.

An embodiment herein provides notifications to user devices when there is an update to the information relevant to the user. Some embodiments herein provide a device oriented products geared to change behaviors regarding the person's rare disease acumen, treatment options, therapy options, knowledge base and level of emotional support and empathy. Some embodiments herein provide products that are created subsequent to the data collection (data analysis) and the internal methodologies of connecting various data points, such as how to connect a sentiment pallet with an emotional pallet with a factual time events, etc.

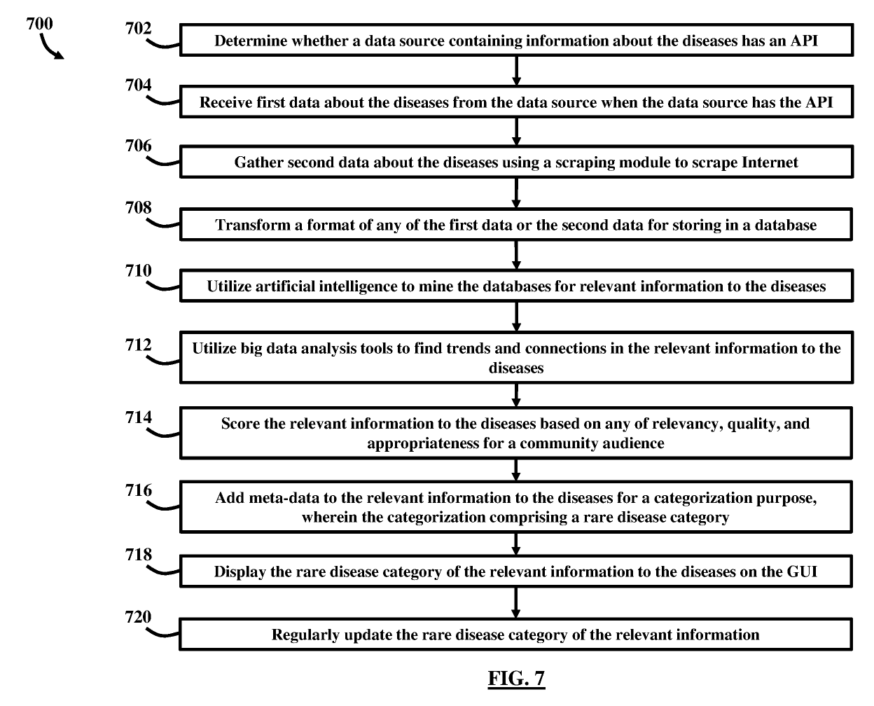

FIG. 7, with reference to FIGS. 1 through 6, is a flowchart illustrating a method 700 for curating medical data about a plurality of diseases for displaying to a user via a graphical user interface (GUI) 600, according to an embodiment herein. The method 700 may include determining (702) whether a data source containing information about the diseases has an API; receiving (704) first data about the diseases from the data source when the data source has the API; gathering (706) second data about the diseases using a scraping module to scrape Internet; transforming (708) a format of any of the first data or the second data for storing in a database; utilizing (710) artificial intelligence to mine the databases for relevant information to the diseases; utilizing (712) big data analysis tools to find trends and connections in the relevant information to the diseases; scoring (714) the relevant information to the diseases based on any of relevancy, quality, and appropriateness for a community audience; adding (716) meta-data to the relevant information to the diseases for a categorization purpose, wherein the categorization comprising a rare disease category; displaying (718) the rare disease category of the relevant information to the diseases on the GUI; and regularly updating (720) the rare disease category of the relevant information.

In an example, the embodiments herein provide a computer program product configured to include a pre-configured set of instructions, which when performed, can result in actions as stated in conjunction with the method(s) described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may comprise a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 8, with reference to FIGS. 1 through 7. This schematic drawing illustrates a hardware configuration of an information handling/computer system 1000 in accordance with an exemplary embodiment herein. The system 1000 comprises at least one processor or central processing unit (CPU) 1010. The CPUs 1010 are interconnected via system bus 1012 to various devices such as a random access memory (RAM) 1014, read-only memory (ROM) 1016, and an input/output (I/O) adapter 1018. The I/O adapter 1018 can connect to peripheral devices, such as disk units 1011 and storage drives 1013, or other program storage devices that are readable by the system. The system 1000 can read the inventive instructions on the program storage devices and follow these instructions to execute the methodology of the embodiments herein. The system 1000 further includes a user interface adapter 1019 that connects a keyboard 1015, mouse 1017, speaker 1024, microphone 1022, and/or other user interface devices such as a touch screen device (not shown) to the bus 1012 to gather user input. Additionally, a communication adapter 1020 connects the bus 1012 to a data processing network 1025, and a display adapter 1021 connects the bus 1012 to a display device 1023, which provides a GUI (e.g., GUI 600) in accordance with the embodiments herein, or which may be embodied as an output device such as a monitor, printer, or transmitter, for example. Further, a transceiver 1026, a signal comparator 1027, and a signal converter 1028 may be connected with the bus 1012 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the description herein.

What is claimed is:

1. A graphical user interface (GUI), said GUI comprising:
a computer-enabled social engagement section configured to enable a user to post about a topic of interest to said user;
a computer-enabled rarerelated panel section configured to present information curated for said user based on said topic for which said user has posted in the social engagement section, to make learning about a disease accessible to said user; and
a computer-enabled communication networks section configured to access linked communication networks in order to present curated information on a computer screen,
wherein said curated information is generated by a compilation module comprising:
a scheduler module configured to receive data from a database and determine a schedule for semantic analysis and curation of said retrieved data;
a metadata information optimization module configured to curated said retrieved data by optimizing metadata of said retrieved data, based on said schedule determined by said scheduler module; and
a semantical analysis module configured to provide semantical analysis on said retrieved data, based on said schedule determined by said scheduler module.

2. The GUI of claim 1, further comprising a computer-enabled emotion web section configured to enable users to show graphically-represented empathy for others using graphical icons, wherein said emotion web section comprises an emotion button section that is configured to, in response to a click by said user, to inquire how said user feels at a time of said inquiry, and accordingly present suggested graphical icons to said user.

3. The GUI of claim 1, further comprising a computer-enabled rarejourney web section configured to present a progression of said disease in a visual timeline comprising a detailed hover modal information and an emotional coloring, wherein said hover modal information provides additional information in a modal popup window, and said emotional coloring comprises a color-coded representation of an experience of said user during a plurality of events in the user's journey with said disease, wherein a specific color represents a specific experience of said user.

4. The GUI of claim 1, further comprising a computer-enabled recruiting near me section configured to provide a location information of a plurality of trial research centers to said user by notifying said user when a center of said plurality of trial research centers is in a pre-specified radius of said user.

5. The GUI of claim 4, wherein said computer-enabled recruiting near me section receives a location input from a global positioning system (GPS) module of a device configured to host said GUI, wherein said device uses said location input to determine said plurality of trial research centers.

6. The GUI of claim 1, further comprising a computer-enabled curated for you section comprising:
a computer-enabled first rare disease web section configured to provide evidence and education about said disease to said user; and
a computer-enabled second rare disease web section configured to provide social and media information to said user.

7. The GUI of claim 6, wherein said computer-enabled curated for you section further comprises:
a computer-enabled third rare disease web section configured to provide news and meetings information to said user;
a computer-enabled fourth rare disease web section configured to play a plurality of videos to said user; and
a computer-enabled fifth rare disease web section configured to provide research grants information to said user.

8. The GUI of claim 7, wherein any of said computer-enabled first rare disease web section, said computer-enabled second rare disease web section, said computer-enabled third rare disease web section, said computer-enabled fourth rare disease web rare disease web section, and said computer-enabled fifth rare disease web section of said computer-enabled curated for you section is configured to be activated and deactivated by a computer device linked to an operator based on any of a level of education, a role in a community, and an experience of said user.

9. The GUI of claim 1, further comprising a computer-enabled clinical trial participation section configured to increase a participation of said user in a clinical trial research by providing a list of clinical trials sorted by increasing to decreasing probability of enrollment of said user.

10. A computer display screen presenting a graphical user interface (GUI), said GUI comprising:
a computer-enabled social engagement section configured to enable a user to post about a topic of interest to said user;
a computer-enabled rarerelated panel section configured to present information curated for said user based on said topic for which said user has posted in said computer-enabled social engagement section, to make learning about a disease more convenient to said user; and
a computer-enabled communication networks section configured to access linked communication networks in order to present curated information on a computer screen,
wherein said curated information is generated by a compilation module comprising:
a scheduler module configured to receive data from a database and determine a schedule for semantic analysis and curation of said retrieved data;
a metadata information optimization module configured to curated said retrieved data by optimizing metadata of said retrieved data, based on said schedule determined by said scheduler module; and
a semantical analysis module configured to provide semantical analysis on said retrieved data, based on said schedule determined by said scheduler module,
wherein said compilation module receives scraped information generated by a scraper module configured to scrape the Internet for information related to said disease.

11. The computer display screen of claim 10, wherein said compilation module receives automatically collected information from application program interfaces (APIs) of a third party website over the Internet.

12. A method for curating medical data about a plurality of diseases for displaying on a computer display screen via a graphical user interface (GUI), said method comprising:
determining whether a data source containing information about said plurality of diseases has an application program interface (API);
receiving first data about said diseases from said data source when said data source has said API;
gathering second data about said diseases using a scraping module to scrape the Internet; and
transforming a format of any of said first data or said second data for storing in a database, wherein said database is communicatively accessible to said GUI and said transformed format of said first and second data is configured to be compatible to be presented on said GUI, and wherein said GUI is hosted on a screen, and said GUI is configured to interact with said API in response to a physical input on said screen when said data source has an API.

13. The method of claim 12, further comprising:
utilizing artificial intelligence to mine said database for relevant information to said diseases;
utilizing a big data analytics tools to find trends and connections in said relevant information to said diseases; and
scoring said relevant information to said diseases based on any of relevancy, quality, and appropriateness for a community audience.

14. The method of claim 13, further comprising:
adding meta-data to said relevant information to said diseases for a categorization purpose, wherein said categorization comprising a rare disease category;
displaying said rare disease category of said relevant information to said diseases on said GUI; and
regularly updating said rare disease category of said relevant information.

15. The method of claim 14, wherein said GUI comprises:
a computer-enabled social engagement section configured to enable a user to post about a topic of interest to said user;
a computer-enabled rarerelated panel section configured to present information curated for said user based on said topic for which said user has posted in said computer-enabled social engagement section, to make learning about said rare disease more convenient to said user; and
a computer-enabled communication networks section configured to access linked communication networks in order to present curated information on a computer screen,
wherein said curated information is generated by a compilation module comprising:
a scheduler module configured to receive data from a database and determine a schedule for semantic analysis and curation of said retrieved data;
a metadata information optimization module configured to curated said retrieved data by optimizing metadata of said retrieved data, based on said schedule determined by said scheduler module; and
a semantical analysis module configured to provide semantical analysis on said retrieved data, based on said schedule determined by said scheduler module.

16. The method of claim 15, wherein said GUI further comprises a computer-enabled emotion web section configured to enable users to show graphically-represented empathy for others using graphical icons, wherein said computer-enabled emotion web section comprises an emotion button section that is configured to, in response to a click by said user, to inquire how said user feels at a time of said inquiry, and accordingly present suggested graphical icons to said user.

17. The method of claim 15, wherein said GUI further comprises a computer-enabled rarejourney web section configured to present a progression of said disease in a visual timeline comprising a detailed hover modal information and an emotional coloring, wherein said hover modal information provides additional information in a modal popup window, and said emotional coloring comprises a color-coded representation of an experience of said user during a plurality of events in the user's journey with said disease, wherein a specific color represents a specific experience of said user.

18. The method of claim 15, wherein said GUI further comprises a computer-enabled recruiting near me section configured to provide a location information of a plurality of trial research centers to said user by notifying said user when a center of said plurality of trial research centers is in a pre-specified radius of said user.

19. The method of claim 15, wherein said computer-enabled recruiting near me section receives a location input from a global positioning system (GPS) module of a device configured to host said GUI, wherein said device uses said location input to determine said plurality of trial research centers.

20. The method of claim 19, wherein said GUI further comprises a computer-enabled curated for you section comprising:
a computer-enabled first rare disease web section configured to provide evidence and education about said disease to said user;
a computer-enabled second rare disease web section configured to provide social and media information to said user;
a computer-enabled third rare disease web section configured to provide news and meetings information to said user;
a computer-enabled fourth rare disease web section configured to play a plurality of videos to said user; and
a computer-enabled fifth rare disease web section configured to provide research grants information to said user,
wherein any of said first rare disease web section, said second rare disease web section, said third rare disease web section, said fourth rare disease web section, and said fifth rare disease web section of said curated for you section is configured to be activated and deactivated by an operator based on any of a level of education, a role in a community, and an experience of said user.
